(19) United States
(12) Patent Application Publication
(10) Pub. No.: US 2020/0186251 A1
(43) Pub. Date: Jun. 11, 2020

(54) OPTICAL SIGNAL REPEATER, METHOD OF REPEATING OPTICAL SIGNAL, AND OPTICAL COMMUNICATION SYSTEM

(71) Applicant: SUMITOMO ELECTRIC INDUSTRIES, LTD., Osaka-shi, Osaka (JP)

(72) Inventor: Naruto TANAKA, Osaka-shi, Osaka (JP)

(73) Assignee: SUMITOMO ELECTRIC INDUSTRIES, LTD., Osaka-shi, Osaka (JP)

(21) Appl. No.: 16/309,243

(22) PCT Filed: Jun. 2, 2017
(86) PCT No.: PCT/JP2017/020582

§ 371 Date: Dec. 12, 2018

(30) Foreign Application Priority Data
Jun. 14, 2016 (JP) 2016-117973

(51) Int. Cl. H04B 10/29; H04B 10/272; H04J 14/02

(52) U.S. Cl. CPC H04B 10/29; H04J 14/0221; H04J 14/0278; H04B 10/272

(57) ABSTRACT

An optical signal repeater includes a separation unit that separates the plurality of optical signals according to wavelengths, a first clock data recovery (CDR) circuit configured to extract a first clock included in a first optical signal of the plurality of optical signals and having a first frequency corresponding to a first rate of the plurality of bit rates, a second CDR circuit configured to extract a second clock included in a second optical signal of the plurality of optical signals and having a second frequency corresponding to a second rate of the plurality of bit rates, a synchronous circuit that is synchronized with the first clock when the first clock is generated and is synchronized with the second clock when the first clock is not generated and the second clock is generated, and a control unit that controls the synchronous circuit.

### TECHNICAL FIELD

The present invention relates to an optical signal repeater, a method of repeating an optical signal, and an optical communication system. The present application claims a priority based on Japanese Patent Application No. 2016-117973 filed on Jun. 14, 2016, the entire content of which is incorporated herein by reference.

### BACKGROUND ART

Fiber to the home (FTTH) has become widespread in homes or corporations. The mainstream FTTH is a point to multi-point (P2MP) system.

A common system of P2MP optical communication system is a passive optical network (PON). The PON system commonly includes an optical line terminal (OLT), one or more optical network units (ONUS), an optical fiber for transmitting an optical signal, and an optical splitter for branching the optical fiber.

For an increased transmission distance between an OLT and an ONU, an optical signal repeater may be placed between the OLT and the ONU. For example, Japanese Patent Laying-Open No. 2008-17323 (PTL 1) discloses a configuration of a PON system including an optical signal repeater.

### CITATION LIST

### Patent Literature

PTL 1: Japanese Patent Laying-Open No. 2008-17323

### SUMMARY OF INVENTION

An optical signal repeater according to one aspect of the present invention is an optical signal repeater that repeats a plurality of optical signals, each of which has a corresponding one of a plurality of bit rates and which are subjected to wavelength multiplexing. The optical signal repeater includes a separation unit, a first clock data recovery (CDR) circuit, a second CDR circuit, a synchronous circuit, and a control unit. The separation unit separates the plurality of optical signals according to wavelengths. The first CDR circuit is configured to extract a first clock included in a first optical signal of the plurality of optical signals and having a first frequency corresponding to a first rate of the plurality of bit rates. The second CDR circuit is configured to extract a second clock included in a second optical signal of the plurality of optical signals and having a second frequency corresponding to a second rate of the plurality of bit rates. The synchronous circuit is synchronized with the first clock when the first clock is generated and is synchronized with the second clock when the first clock is not generated and the second clock is generated. The control unit controls the synchronous circuit.

A method of repeating an optical signal according to one aspect of the present invention is a method of repeating an optical signal for repeating a plurality of optical signals, each of which has a corresponding one of a plurality of bit rates and which are subjected to wavelength multiplexing. The method includes separating the plurality of optical signals according to wavelengths, extracting a first clock included in a first optical signal of the plurality of optical signals and having a first frequency corresponding to a first rate of the plurality of bit rates, extracting a second clock included in a second optical signal of the plurality of optical signals and having a second frequency corresponding to a second rate of the plurality of bit rates, synchronizing a synchronous circuit with the first clock to generate a reference clock when the first clock is generated, synchronizing the synchronous circuit with the second clock when the first clock is not generated and the second clock is generated, and repeating an optical signal having the first rate using the reference clock. An optical communication system according to one aspect of the present invention includes an optical line terminal, an optical communication line, a plurality of optical network units, and an optical signal repeater. The optical line terminal multiplexes a plurality of optical signals, each of which has a corresponding one of a plurality of bit rates and has a corresponding one of a plurality of wavelengths each corresponding to one of the plurality of bit rates, in accordance with a wavelength division multiplexing mode and transmits a multiplex optical signal. The optical communication line is provided for transmitting the plurality of optical signals from the optical line terminal. Each of the plurality of optical network units is connected to the optical communication line to receive an optical signal having a corresponding rate of the plurality of bit rates. The optical signal repeater is provided partway along the optical communication line. The optical signal repeater includes a separation unit, a first clock data recovery (CDR) circuit, a second CDR circuit, a synchronous circuit, and a control unit. The separation unit separates the plurality of optical signals according to wavelengths. The first CDR circuit is configured to extract a first clock included in a first optical signal of the plurality of optical signals and having a first frequency corresponding to a first rate of the plurality of bit rates. The second CDR circuit is configured to extract a second clock included in a second optical signal of the plurality of optical signals and having a second frequency corresponding to a second rate of the plurality of bit rates. The synchronous circuit is synchronized with the first clock when the first clock is generated and is synchronized with the second clock when the first clock is not generated and the second clock is generated. The control unit controls the synchronous circuit.

### BRIEF DESCRIPTION OF DRAWINGS

FIG. 1 is a schematic diagram showing a configuration example of an optical communication system according to Embodiment 1 of the present invention.

FIG. 2 is a block diagram showing a schematic configuration of a signal reproducing and processing unit of an optical signal repeater shown in FIG. 1.

FIG. 3 shows a state before a transmission service at a first rate is started in the optical signal repeater according to Embodiment 1 of the present invention.

FIG. 4 shows a state after a transmission service at a second rate has been started in the optical signal repeater according to Embodiment 1 of the present invention.

FIG. 5 shows a schematic configuration example of a PLL circuit for first rate.

FIG. 6 shows a schematic configuration example of a PLL circuit for second rate.

FIG. 7 is a flowchart for determining the presence or absence of a service at a rate of a plurality of rates according to an embodiment of the present invention.

FIG. 8 is a flowchart showing control of a signal reproducing and processing unit according to an embodiment of the present invention.

FIG. 9 is a schematic diagram showing a configuration example of an optical communication system according to Embodiment 2 of the present invention.

FIG. 10 is a block diagram showing in more detail a configuration related to the transmission of an upstream signal in the optical signal repeater shown in FIG. 9.

### DETAILED DESCRIPTION

[Problem to be Solved by the Present Disclosure]

A PON system configured to perform data communications at a plurality of bit rates (multiple rates) has been proposed. When an optical signal repeater is adopted in such a PON system, the optical signal repeater also needs to be capable of repeating data at multiple rates. Japanese Patent Laying-Open No. 2008-17323 discloses data transmission at a single rate (1.25 Gbps) but does not disclose data transmission at multiple rates.

A clock data recovery (CDR) is commonly used for transmission of digital data. In the CDR, it is important to rapidly stabilize a frequency adapted to a clock and data for extracting the data and the clock from the signal. At the start of a service at a predetermined rate, however, it may take time to stabilize an adapted frequency. In such a case, the start of the service at that rate may delay.

An object of the present disclosure is to provide an optical signal repeater capable of rapidly starting a service at a desired rate of multiple rates, a method of controlling the same, and an optical communication system.

### Advantageous Effect of the Present Disclosure

Embodiments of the present invention will be initially listed and described.

(1) An optical signal repeater according to one aspect of the present invention is an optical signal repeater that repeats a plurality of optical signals, each of which has a corresponding one of a plurality of bit rates and which are subjected to wavelength multiplexing. The optical signal repeater includes a separation unit, a first clock data recovery (CDR) circuit, a second CDR circuit, a synchronous circuit, and a control unit. The separation unit separates the plurality of optical signals according to wavelengths. The first CDR circuit is configured to extract a first clock included in a first optical signal of the plurality of optical signals and having a first frequency corresponding to a first rate of the plurality of bit rates. The second CDR circuit is configured to extract a second clock included in a second optical signal of the plurality of optical signals and having a second frequency corresponding to a second rate of the plurality of bit rates. The synchronous circuit is synchronized with the first clock when the first clock is generated and is synchronized with the second clock when the first clock is not generated and the second clock is generated. The control unit controls the synchronous circuit.

According to the above, an optical signal repeater capable of rapidly starting a service at a desired rate of a plurality of rates can be provided. When the first optical signal is generated, the synchronous circuit is synchronized with the first clock. A transmission service at the first rate can thus be provided. On the other hand, when the first clock is not generated, the transmission service at the first rate is not provided. When the synchronous circuit is stopped, however, it may take time for the synchronous circuit to stabilize a frequency at the start of the transmission service at the first rate. Synchronization of the synchronous circuit with the second clock can accelerate the start of the transmission service at the first rate.

The optical signal repeater may include more than two CDR circuits. When three or more CDR circuits are included in the optical signal repeater, the first CDR circuit and the second CDR circuit can be appropriately selected from a plurality of CDR circuits.

Each CDR circuit may extract a clock from an optical signal. For example, an optical signal may be converted into an electric signal, and each CDR circuit may extract a clock from the electric signal.

Although the synchronous circuit is, for example, a phase locked loop (PLL) circuit, it is not limited thereto.

(2) In the optical signal repeater of (1), the control unit determines the presence or absence of a transmission service at a first rate based on input optical power at the first rate and controls the synchronous circuit based on a result of the determination. According to the above, whether a first optical signal has been generated can be determined. This allows for appropriate control of the synchronous circuit.

(3) In the optical signal repeater of (1) or (2), the control unit determines the presence or absence of the transmission service at the first rate based on a frequency of the first clock and controls the synchronous circuit based on a result of the determination.

According to the above, whether the frequency of the clock extracted from the first CDR circuit is a frequency suitable for repeating at the first rate can be determined. This allows for appropriate control of the synchronous circuit.

(4) The optical signal repeater according to any one of (1) to (3) further includes a data processing unit that performs, on data included in the first optical signal, a process for repeating the data. With the transmission service at the first rate not being provided, the control unit stops the data processing unit.

According to the above, the power consumption of the optical signal repeater can be reduced before the transmission service at the first rate is started.

(5) A method of repeating an optical signal according to one aspect of the present invention is a method of repeating an optical signal for repeating a plurality of optical signals, each of which has a corresponding one of a plurality of bit rates and which are subjected to wavelength multiplexing. The method includes separating the plurality of optical signals according to wavelengths, extracting a first clock included in a first optical signal of the plurality of optical signals and having a first frequency corresponding to a first rate of the plurality of bit rates, extracting a second clock included in a second optical signal of the plurality of optical signals and having a second frequency corresponding to a second rate of the plurality of bit rates, synchronizing a synchronous circuit with the first clock to generate a reference clock when the first clock is generated, synchronizing the synchronous circuit with the second clock when the first clock is not generated and the second clock is generated, and repeating an optical signal having the first rate using the reference clock.

According to the above, a method of repeating an optical signal can be provided that can rapidly start a service at a desired rate of a plurality of rates.

(6) An optical communication system according to one aspect of the present invention includes an optical line terminal, an optical communication line, a plurality of optical network units, and an optical signal repeater. The optical line terminal multiplexes a plurality of optical signals, each of which has a corresponding one of a plurality of bit rates and has a corresponding one of a plurality of wavelengths each corresponding to one of the plurality of bit rates, in accordance with a wavelength division multiplexing mode and transmits a multiplex optical signal. The optical communication line is provided for transmitting the plurality of optical signals from the optical line terminal. Each of the plurality of optical network units is connected to the optical communication line to receive an optical signal having a corresponding rate of the plurality of bit rates. The optical signal repeater is provided partway along the optical communication line. The optical signal repeater includes a separation unit, a first clock data recovery (CDR) circuit, a second CDR circuit, a synchronous circuit, and a control unit. The separation unit separates the plurality of optical signals according to wavelengths. The first CDR circuit is configured to extract a first clock included in a first optical signal of the plurality of optical signals and having a first frequency corresponding to a first rate of the plurality of bit rates. The second CDR circuit is configured to extract a second clock included in a second optical signal of the plurality of optical signals and having a second frequency corresponding to a second rate of the plurality of bit rates. The synchronous circuit is synchronized with the first clock when the first clock is generated and is synchronized with the second clock when the first clock is not generated and the second clock is generated. The control unit controls the synchronous circuit.

According to the above, an optical communication system capable of rapidly starting a service at a desired rate of a plurality of rates can be provided.

(7) In the optical communication system of (6), the first rate and the second rate each generated in the optical line terminal are synchronized with each other.

According to the above, the synchronous circuit can rapidly stabilize the frequency of a clock at the start of the service at the first rate.

### DESCRIPTION OF EMBODIMENTS

Embodiments of the present invention will now be described with reference to the drawings. The same or corresponding elements in the drawings have the same references, and description thereof will not be repeated.

An optical communication system according to the embodiments of the present invention is a P2MP optical communication system. A PON system will be represented below as one P2MP optical communication system.

### Embodiment 1

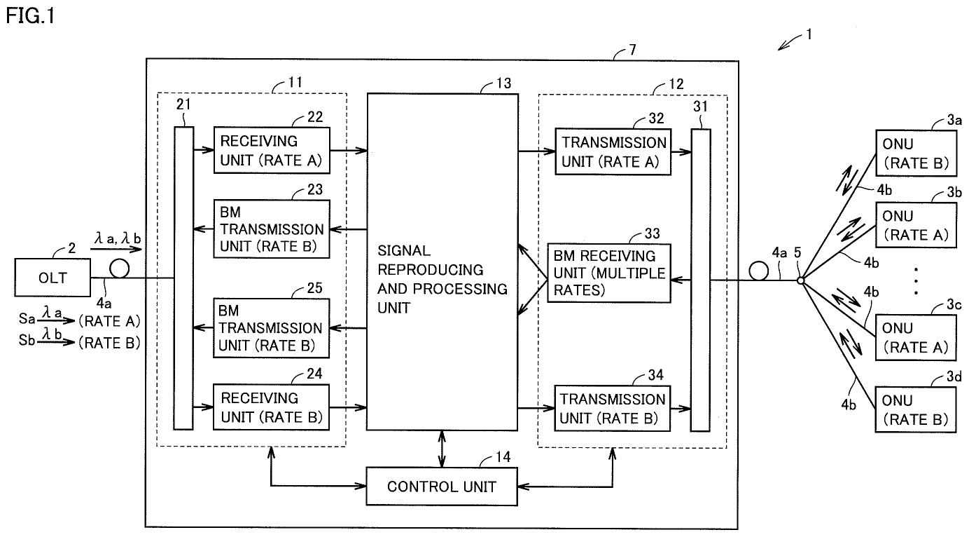

FIG. 1 is a schematic diagram showing a configuration example of an optical communication system 1 according to Embodiment 1 of the present invention. With reference to FIG. 1, optical communication system 1 includes an optical line terminal (OLT) 2, optical network units (ONUs) 3a, 3b, . . . , 3c, 3d, a trunk optical fiber 4a, a plurality of branch optical fibers 4b, an optical coupler 5, and an optical signal repeater 7.

Optical line terminal 2 is connected to, for example, an office and terminates an optical signal from each of the plurality of optical network units. Each of the plurality of optical network units is placed on a corresponding subscriber side. Hereinafter, the optical line terminal is referred to as an “OLT”, and the optical network unit is referred to as an “ONU”. FIG. 1 shows four ONUs. However, the number of ONUs is not limited to four. ONUs 3a, 3b, 3c, and 3d of the plurality of ONUs will be representatively described below.

Trunk optical fiber 4a is connected to OLT 2. Each branch optical fiber 4b is connected to a corresponding ONU. Optical coupler 5 connects trunk optical fiber 4a to branch optical fibers 4b. Trunk optical fiber 4a, branch optical fibers 4b, and optical coupler 5 form an optical communication network in optical communication system 1. Optical signal repeater 7 is provided partway along trunk optical fiber 4a.

Optical communication system 1 has a plurality of bit rates (hereinafter, also merely referred to as “rates”). FIG. 1 shows two types of rates, namely, “rate A” and “rate B”.

In one example, “rate A” and “rate B” comply with the Institute of Electrical and Electronics Engineers, Inc. (IEEE) 802.3 standards. According to the IEEE 802.3 standards, the PON standards include GE-PON and 10G-EPON. The bit rate of the GE-PON is 1.25 gigabits per second (Gbps). The bit rate of the 10G-EPON is 10.3125 Gbps. For example, rate A may be 1.25 Gbps, and rate B may be 10.3125 Gbps.

OLT 2 can receive both of an upstream signal at rate A and an upstream signal at rate B. OLT 2 can further transmit a downstream signal at rate A and a downstream signal at rate B.

In the present embodiment, the wavelength of a downstream optical signal differs for each rate. OLT 2 multiplexes optical signals Sa and Sb respectively having wavelengths λa and λb in accordance with the wavelength division multiplexing mode. Optical signals Sa and Sb are respectively a downstream optical signal having rate A and a downstream optical signal having rate B. OLT 2 transmits a resultant multiplex optical signal.

Each of ONUS 3a to 3d is a device for allowing a subscriber to enjoy an optical network service. Each ONU transmits an upstream optical signal and receives a downstream optical signal in accordance with the rate of the ONU. The rate of each ONU is rate A or rate B.

Optical coupler 5 is connected to trunk optical fiber 4a and branch optical fibers 4b. Optical coupler 5 distributes optical signals transmitted through trunk optical fiber 4a to branch optical fibers 4b. On the other hand, optical coupler 5 multiplexes the optical signals transmitted from branch optical fibers 4b and transmits a resultant multiplex optical signal to trunk optical fiber 4a. Optical coupler 5 can include, for example, an optical star coupler.

OLT 2 communicates with each of ONUs 3a, 3b, 3c, and 3d on a variable-length frame basis. A terminal device of each subscriber transmits data. The data is converted into an optical burst signal by the ONU. The optical burst signal is configured of bits.

The optical burst signals from the respective ONUs are multiplexed by optical coupler 5. A multiplex optical burst signal is transmitted to optical signal repeater 7 through trunk optical fiber 4a.

OLT 2 transmits a control frame to each of ONUs 3a to 3d. The control frame allocates a time window for transmission of an upstream optical signal to each ONU. This prevents a collision of optical burst signals from the respective ONUs. Such a method allows OLT 2 to determine a transmission rate and a reception timing of an optical burst signal to be received.

Optical signal repeater 7 is a device that is provided partway along the optical communication line and repeats an optical signal. Optical signal repeater 7 can increase the transmission distance between OLT 2 and the ONU.

Optical signal repeater 7 includes optical transmission and receiving units 11 and 12, a signal reproducing and processing unit 13, and a control unit 14. Optical transmission and receiving unit 11 transmits an upstream optical signal to OLT 2 and also receives a downstream optical signal from OLT 2. Optical transmission and receiving unit 12 transmits a downstream optical signal to trunk optical fiber 4a. Optical transmission and receiving unit 12 receives optical signals from ONUs 3a to 3d.

Optical transmission and receiving unit 11 includes a wavelength division multiplexing (WDM) filter 21, a receiving unit 22, a burst mode (BM) transmission unit 23, a receiving unit 24, and a BM transmission unit 25. WDM filter 21 is a separation unit that separates a wavelength-multiplexed optical signal transmitted from OLT 2 into a plurality of optical signals according to wavelengths. On the other hand, an optical signal (subjected to time division multiplexing) having a wavelength different from that of the optical signal transmitted from OLT 2 is transmitted from each of BM transmission unit 23 and BM transmission unit 25 to WDM filter 21. WDM filter 21 multiplexes the two optical signals and transmit a resultant signal to OLT 2.

Receiving unit 22 receives a downstream signal (rate A) output in the form of an optical signal from WDM filter 21. Receiving unit 22 includes a light receiving element, converts an optical signal thereof into an electric signal, and outputs the electric signal to signal reproducing and processing unit 13.

BM transmission unit 23 receives an upstream signal (rate A) output from signal reproducing and processing unit 13 in the form of an electric signal. BM transmission unit 23 includes a light emitting element, converts an electric signal thereof into an optical signal, and outputs the optical signal to WDM filter 21.

Receiving unit 24 receives a downstream signal (rate B) output in the form of, an optical signal from WDM filter 21. Receiving unit 24 includes a light receiving element, converts an optical signal thereof into an electric signal, and outputs the electric signal to signal reproducing and processing unit 13.

BM transmission unit 25 receives an upstream signal (rate B) output in the form of an electric signal from signal reproducing and processing unit 13. BM transmission unit 25 includes a light emitting element, converts an electric signal thereof into an optical signal, and outputs the optical signal to WDM filter 21.

Optical transmission and receiving unit 12 includes a WDM filter 31, a transmission unit 32, a BM receiving unit 33, and a transmission unit 34. WDM filter 31 multiplexes two respective optical signals transmitted from transmission unit 32 and transmission unit 34 to generate a wavelength-multiplexed optical signal. On the other hand, a plurality of optical signals transmitted from ONUs 3a to 3d are multiplexed by optical coupler 5. A plurality of upstream signals cannot be separated according to wavelengths. The plurality of upstream signals thus cannot be separated by WDM filter 31.

Transmission unit 32 receives a downstream signal (rate A) output in the form of an electric signal from signal reproducing and processing unit 13. Transmission unit 32 includes a light emitting element, converts an electric signal thereof into an optical signal, and outputs the optical signal to WDM filter 31.

BM receiving unit 33 receives an upstream signal output in the form of an optical signal from WDM filter 31. BM receiving unit 33 includes a light receiving element, converts an optical signal thereof into an electric signal, and outputs the electric signal to signal reproducing and processing unit 13. BM receiving unit 33 receives a plurality of upstream signals to be transmitted at different rates. In other words, BM receiving unit 33 can receive upstream data transmitted at multiple rates.

Transmission unit 34 receives a downstream signal (rate B) output in the form of an electric signal from signal reproducing and processing unit 13. Transmission unit 34 includes a light emitting element, converts an electric signal thereof into an optical signal, and outputs the optical signal to WDM filter 31.

Signal reproducing and processing unit 13 receives a downstream signal (rate A) from receiving unit 22. Signal reproducing and processing unit 13 performs a process for reproducing the downstream signal. Signal reproducing and processing unit 13 outputs a processed signal to transmission unit 32. Signal reproducing and processing unit 13 performs a similar process on a downstream signal (rate B) from receiving unit 24 and outputs a processed signal to transmission unit 34. Further, signal reproducing and processing unit 13 processes an upstream signal (rate A or rate B) from BM receiving unit 33 and outputs a processed signal to BM transmission unit 23 or BM transmission unit 25 according to a rate of the signal. For example, signal reproducing and processing unit 13 can be implemented by a field programmable gate array (FPGA).

Control unit 14 controls optical transmission and receiving units 11 and 12 and signal reproducing and processing unit 13 in a centralized manner. Control unit 14 can be implemented by, for example, a central processing unit (CPU). Control of signal reproducing and processing unit 13 by control unit 14 will be described below in detail.

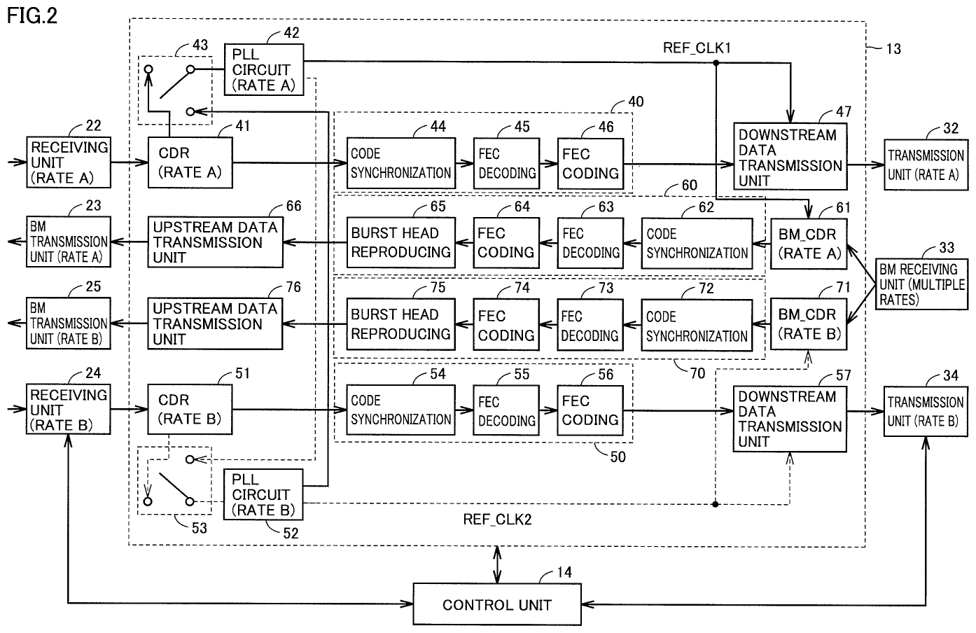

FIG. 2 is a block diagram showing a schematic configuration of signal reproducing and processing unit 13 of optical signal repeater 7 shown in FIG. 1. With reference to FIG. 2, signal reproducing and processing unit 13 includes data processing units 40, 50, 60, and 70, CDR circuits 41 and 51, phase locked loop (PLL) circuits 42 and 52, selection units 43 and 53, downstream data transmission units 47 and 57, upstream data transmission units 66 and 76, and BM_CDR circuits 61 and 71.

CDR circuit 41 receives a downstream signal (rate A) from receiving unit 22 and extracts a clock and data from the downstream signal. PLL circuit 42 synchronizes the phase of the input clock and the phase of a clock to be output from PLL circuit 42 with each other. PLL circuit 42 outputs a reference clock REF_CLK1.

Selection unit 43 selects one of a first clock output from CDR circuit 41 and a clock output from PLL circuit 52. The selected clock is input to PLL circuit 42.

Selection unit 43 is controlled by control unit 14. PLL circuit 42 is accordingly controlled by control unit 14.

Data processing units 40, 50, 60, and 70 perform a process for repeating data. Specifically, data processing units 40 and 50 perform the process on downstream data. Data processing units 60 and 70 perform the process on upstream data.

Data processing unit 40 includes a code synchronization circuit 44, a forward error correction (FEC) decoding circuit 45, and an FEC coding circuit 46. Code synchronization circuit 44 performs code synchronization of data. FEC decoding circuit 45 performs a forward error correction (FEC) on data and decodes the data. FEC coding circuit 46 adds an error correcting code to the decoded data. Downstream data transmission unit 47 receives downstream data from data processing unit 40 and reference clock REF_CLK1 and transmits coded data to transmission unit 32.

CDR circuit 51 receives a downstream signal (rate B) from receiving unit 24 and extracts a clock and data from the downstream signal. PLL circuit 52 synchronizes the phase of the input clock and the phase of a clock to be output from PLL circuit 52 with each other. PLL circuit 52 outputs a reference clock REF_CLK2.

Selection unit 53 selects one of a clock from CDR circuit 51 and a clock output from PLL circuit 52. The selected clock is input to PLL circuit 52. For example, selection unit 53 is controlled by control unit 14. PLL circuit 52 is accordingly controlled by control unit 14.

Data processing unit 50 includes a code synchronization circuit 54, an FEC decoding circuit 55, and an FEC coding circuit 56. Code synchronization circuit 54, FEC decoding circuit 55, and FEC coding circuit 56 respectively have the same functions as those of code synchronization circuit 44, FEC decoding circuit 45, and FEC coding circuit 46. Downstream data transmission unit 57 receives downstream data from data processing unit 50 and reference clock REF_CLK2 and transmits coded data to transmission unit 34.

Data processing unit 60 includes a code synchronization circuit 62, an FEC decoding circuit 63, an FEC coding circuit 64, and a burst head reproducing circuit 65. BM_CDR circuit 61 receives an upstream signal (rate A) from BM receiving unit 33 and extracts a clock and data from the upstream signal using reference clock REF_CLK1. Code synchronization circuit 62 performs code synchronization of data. FEC decoding circuit 63 performs error correction and decoding of data. FEC coding circuit 64 adds an error correcting code to the data. Burst head reproducing circuit 65 reproduces the head part of a burst signal (upstream data). Upstream data transmission unit 66 outputs upstream data from data processing unit 60 to BM transmission unit 23.

Data processing unit 70 includes a code synchronization circuit 72, an FEC decoding circuit 73, an FEC coding circuit 74, and a burst head reproducing circuit 75. BM_CDR circuit 71, code synchronization circuit 72, FEC decoding circuit 73, FEC coding circuit 74, and burst head reproducing circuit 75 respectively have the same functions as those of BM_CDR circuit 61, code synchronization circuit 62, FEC decoding circuit 63, FEC coding circuit 64, and burst head reproducing circuit 65. Upstream data transmission unit 76 outputs upstream data from data processing unit 70 to BM transmission unit 25.

In the present embodiment, a first clock and a second clock may be respectively a clock from CDR circuit 41 and a clock from CDR circuit 51. Alternatively, the first clock and the second clock may be respectively a clock from CDR circuit 51 and a clock from CDR circuit 41.

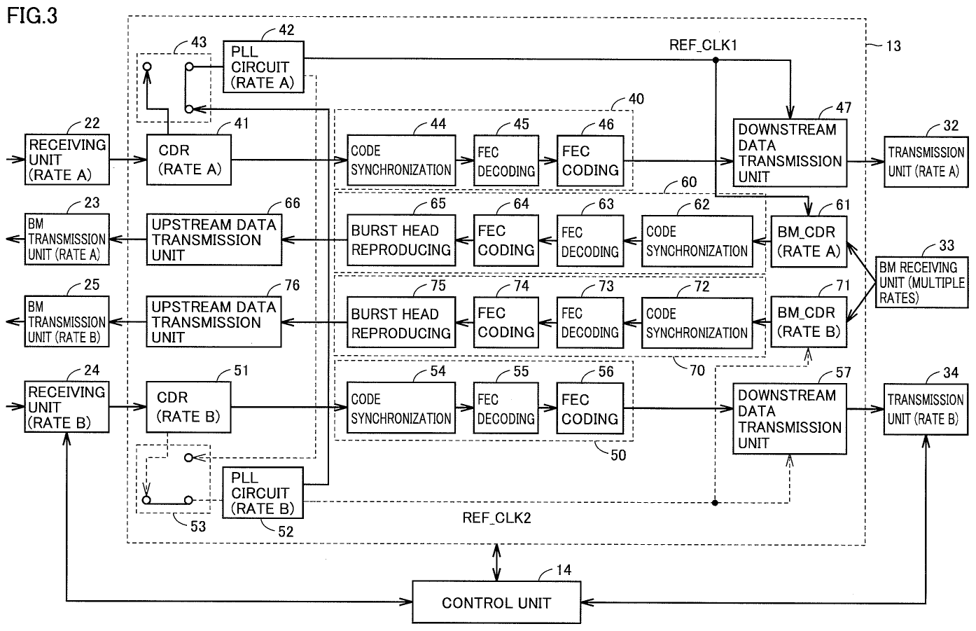

FIG. 3 shows a state before a transmission service at the first rate (rate A) is started in optical signal repeater 7 according to Embodiment 1 of the present invention. With reference to FIG. 3, the transmission service at rate B has been established in optical signal repeater 7. Thus, CDR circuit 51 generates a clock (e.g., second clock). However, the transmission service at rate A has not been started. CDR circuit 41 thus does not generate a clock (e.g., first clock). In this case, selection unit 43 selects a clock output from PLL circuit 52 as an input clock of PLL circuit 42. PLL circuit 42 is synchronized with a clock output from PLL circuit 52. The clock output from PLL circuit 52 is a clock originally included in a downstream optical signal at rate B. In other words, PLL circuit 42 is synchronized with a clock (e.g., second clock) at rate B.

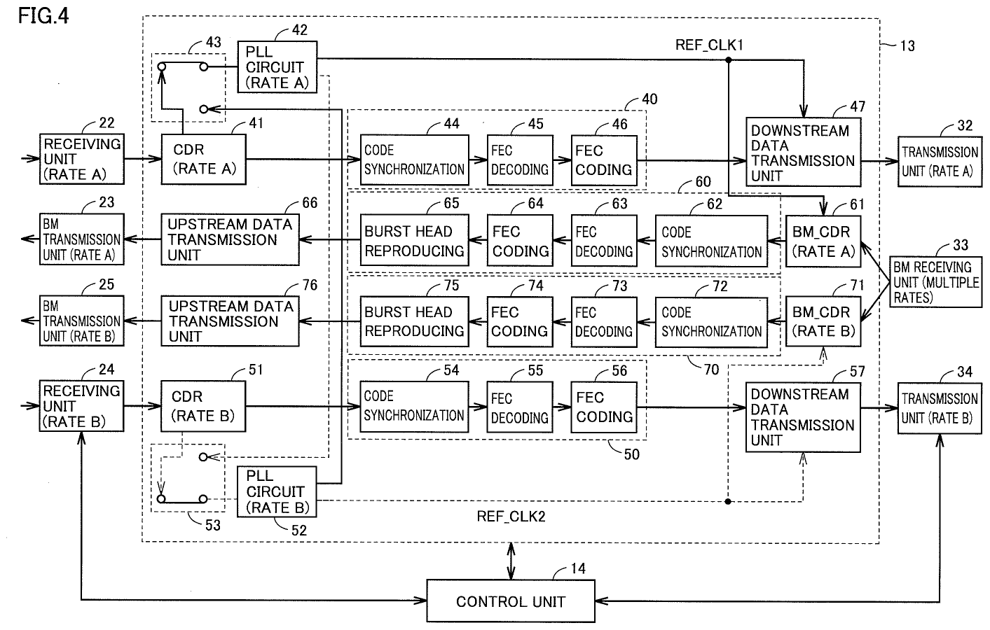

FIG. 4 shows a state after a transmission service at second rate (rate B) has been started in the optical signal repeater according to Embodiment 1 of the present invention. With reference to FIG. 4, after the transmission service at rate A has been started, selection unit 43 selects a clock extracted from the downstream signal at rate A as an input clock of PLL circuit 42. In other words, a clock output from CDR circuit 41 is input to PLL circuit 42. PLL circuit 42 is accordingly synchronized with a clock (e.g., first clock) at rate A.

The transmission service at rate A is provided, whereas selection unit 43 selects a clock output from CDR circuit 41 as an input clock of PLL circuit 42 in the state before the transmission service at rate B is provided. On the other hand, selection unit 53 selects a clock output from PLL circuit 42 as an input clock of PLL circuit 52.

Rate A and rate B differ from each other. The frequency of a clock extracted from a downstream signal by CDR circuit 41 accordingly differs from the frequency of a clock extracted from a downstream signal by CDR circuit 51. Reference clock REF_CLK1 and reference clock REF_CLK2 accordingly differ from each other in frequency.

PLL circuit 42 and PLL circuit 52 can multiply or divide the frequency of an input clock. PLL circuit 42 can accordingly generate reference clock REF_CLK1 from a clock output from PLL circuit 52. Similarly, PLL circuit 52 can generate reference clock REF_CLK2 from a clock output from PLL circuit 42.

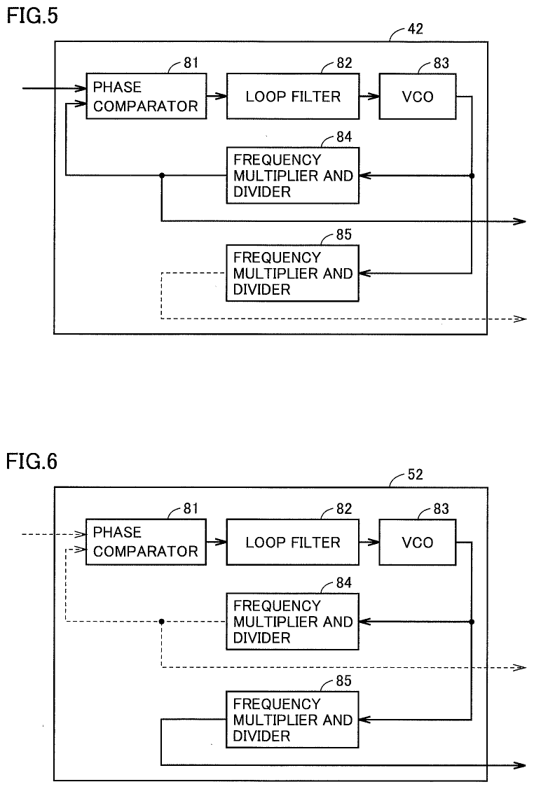

FIG. 5 shows a schematic configuration example of PLL circuit 42 for the first rate (rate A). FIG. 6 shows a schematic configuration example of PLL circuit 52 for the second rate (rate B). With reference to FIG. 5, PLL circuit 42 includes a phase comparator 81, a loop filter 82, a voltage controlled oscillator (VCO) 83, a frequency multiplier and divider 84, and a frequency multiplier and divider 85. With reference to FIG. 6, the configuration of PLL circuit 52 is identical to the configuration of PLL circuit 42. Thus, PLL circuit 42 will be representatively described below.

PLL circuit 42 receives an input of a clock extracted by a CDR for own rate or a clock output from a PLL circuit for another rate. Frequency multiplier and divider 84 is a frequency multiplier and divider corresponding to the frequency of the clock for own rate, and multiplies and divides the frequency of a clock output from VCO 83. An output clock from frequency multiplier and divider 84 is fed back to phase comparator 81 and is also output from PLL circuit 42 as a clean clock for own rate. On the other hand, frequency multiplier and divider 85 is a multiplier and frequency divider corresponding to the frequency of the clock for another rate. Frequency multiplier and divider 85 multiplies and divides the output of VCO 83, and then outputs a clean clock for another rate.

PLL circuit 42 receives an input of a clock extracted by the CDR for own rate or a clock output from the PLL circuit for another rate. Frequency multiplier and divider 84 is a frequency multiplier and divider corresponding to the frequency of a clock for own rate, and multiplies and divides the frequency of the clock output from VCO 83. The output clock from frequency multiplier and divider 84 is fed back to phase comparator 81 and is also output from PLL circuit 42 as a clean clock for own rate. On the other hand, frequency multiplier and divider 85 is a frequency multiplier and divider corresponding to the frequency of a clock for another rate. Frequency multiplier and divider 85 multiplies and divides the frequency of the output clock from VCO 83, and then outputs a clean clock for another rate.

For example, PLL circuit 42 multiplies the frequency of an input signal to a rate corresponding to a least common multiple of rate A and rate B and then divides the multiplied frequency. PLL circuit 42 can accordingly generate reference clock REF_CLK1 for rate A based on the clock extracted from the signal at rate B. Similarly, PLL circuit 52 can generate reference clock REF_CLK2 for rate B based on the clock extracted from the signal at rate A.

According to one aspect, rate A and rate B each generated by OLT 2 are synchronized with each other. According to the present embodiment, OLT 2 generates a signal at a rate corresponding to a least common multiple of rate A and rate B. OLT 2 generates a clock at rate A and a clock at rate B by dividing the frequency of the signal. Consequently, at the start of the service at rate A, PLL circuit 42 can rapidly stabilize the frequency of a clock. Alternatively, at the start of the service at rate B, PLL circuit 52 can rapidly stabilize the frequency of a clock.

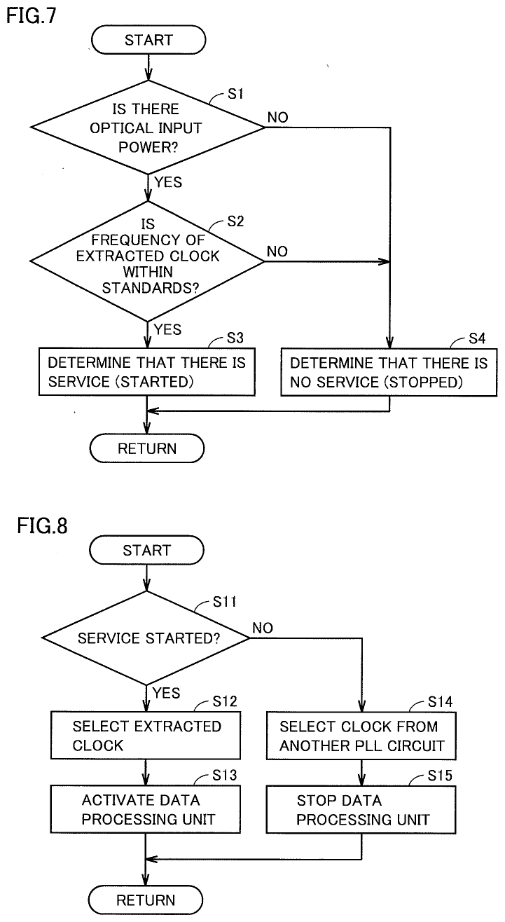

FIG. 7 is a flowchart for determining the presence or absence of a service at a rate of a plurality of rates according to an embodiment of the present invention. The processes of this flowchart are performed by control unit 14, for example, in certain cycles.

With reference to FIGS. 2 and 7, in step S1, control unit 14 determines the presence or absence of optical input power in the downstream signal receiving unit (receiving unit 22 or receiving unit 24). When a downstream optical signal is input to a receiving unit, the receiving unit outputs a signal corresponding to the power of the input light to a corresponding CDR circuit. For example, control unit 14 may monitor average power of the input power in receiving unit 22 over a predetermined period of time and determine whether optical input power at rate A has been generated in receiving unit 22. Similarly, control unit 14 may monitor average power of the input power in receiving unit 24 over a predetermined period of time and determine whether optical input power at rate B has been generated in receiving unit 24.

If optical input power has been generated (YES in step S1), the process proceeds to step S2. In this case, CDR circuit 41 extracts a clock (e.g., first clock) from a downstream signal (rate A). In step S2, control unit 14 determines whether the frequency of the extracted clock is within the standards of the clock frequency required for the transmission service at rate A. Control unit 14 can count, for example, the extracted clocks to determine whether the frequencies of the extracted clocks are within the standards.

If the frequency of the extracted clock is within the standards (YES in step S2), the process proceeds to step S3. In step S3, control unit 14 determines that there is the transmission service at that rate (e.g., rate A) or the transmission service at that rate has been started.

On the other hand, if there is no optical power input (NO in step S1), or if the frequency of the extracted clock is out of the standards (NO in step S2), the process proceeds to step S4. In step S4, control unit 14 determines that there is no transmission service at that rate or the transmission service at that rate has been stopped.

FIG. 8 is a flowchart showing control of signal reproducing and processing unit 13 according to an embodiment of the present invention. The processes of this flowchart are performed by control unit 14, for example, in certain cycles.

With reference to FIGS. 2 and 8, in step S11, control unit 14 determines whether the transmission service at a rate has been started. This determination is performed in accordance with the flowchart shown in FIG. 7. An example of starting the service (transmission service) at rate A will be described below.

If determining that the transmission service at rate A has been started (YES in step S11), in step S12, control unit 14 selects a clock extracted from a downstream signal (rate A) by CDR circuit 41 as an input clock of PLL circuit 42. Selection unit 43 selects a clock output from CDR circuit 41 as an input of PLL circuit 42.

In step S13 subsequent to step S12, control unit 14 activates data processing units 40 and 50. Data processing units 40 and 50 are data processing units for transmission (upstream and downstream) at rate A.

CDR circuit 41 and BM_CDR circuit 61 are activated before start of transmission at rate A. Downstream data transmission unit 47 and upstream data transmission unit 66 may be activated together with data processing units 40 and 50 or may have been activated before start of the transmission at rate A. If the transmission service has been started, the process of step S13 can be skipped.

On the other hand, if control unit 14 determines that the transmission service at rate A has not been started (NO in step S11), the process proceeds to step S14. In step S14, control unit 14 selects a clock output from PLL circuit 52 as an input clock of PLL circuit 42. In this case, selection unit 43 selects a clock output from PLL circuit 52 as an input clock of PLL circuit 42.

In step S15 subsequent to step S14, control unit 14 stops data processing units 40 and 50. For example, control unit 14 may stop a supply of power supply voltage to data processing unit 40. If the service is being stopped, the process of step S14 can be skipped.

Each of PLL circuits 42 and 52 performs phase synchronization with a downstream optical signal and eliminates jitter of an extracted clock (timing signal). Each of PLL circuits 42 and 52 is implemented for network synchronization of optical communication system 1 including optical signal repeater 7 and is implemented in optical communication system 1. PLL circuits 42 and 52 have a multiplying and frequency dividing function and generate clocks having different frequencies through synchronization with an extracted clock using the function.

Since start-up of PLL circuits 42 and 52 are slow (a time constant is large), it takes some time (e.g., time in minutes) for stabilization of the frequencies of the clocks output from PLL circuits 42 and 52. The start of the transmission service at a rate may be waited until the frequency of a clock used for transmission at that rate is stabilized.

According to Embodiment 1, before start of the transmission service at a rate (e.g., rate A) of a plurality of rates, the PLL circuit (e.g., PLL circuit 42) for that rate is activated, and the service is synchronized with a clock at another rate at which a service has been started. Thus, at the start of a service at a desired rate, the start of the transmission service at that rate can be advanced. Embodiment 1 can reduce a time required for starting a service to, for example, a time in minutes even when, for example, a time required for stabilizing a frequency in a PLL circuit is a time in minutes.

Further, data processing units (e.g., data processing units 40 and 50) that are in charge of the transmission service are stopped before start of the service. A time (e.g., time constant) required for activating these is smaller than the time constant of the PLL circuit. The power consumption of optical signal repeater 7 can thus be reduced before start of the service. Further, the data processing units can start up rapidly at the start of a service, reducing an effect on data transmission.

### Embodiment 2

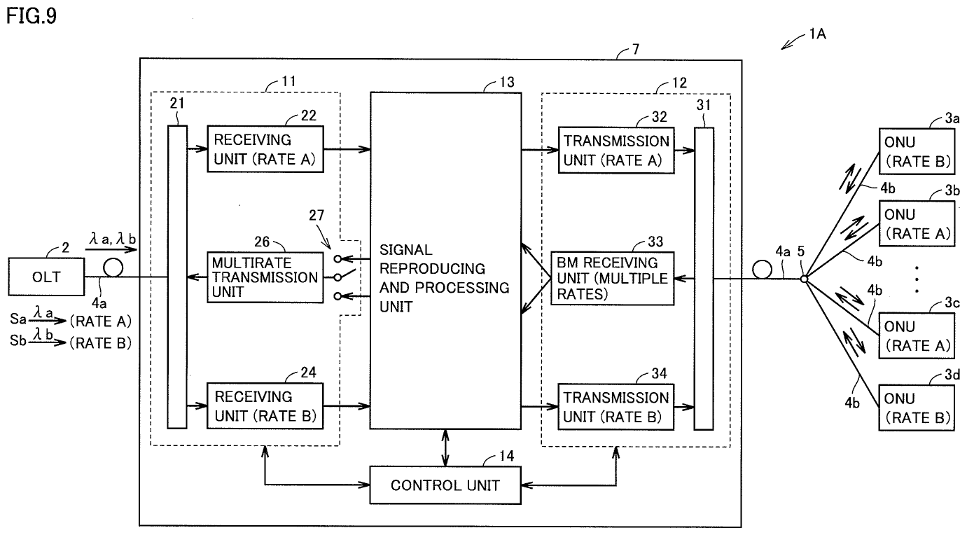

FIG. 9 is a schematic diagram showing a configuration example of an optical communication system 1A according to Embodiment 2 of the present invention. With reference to FIGS. 1 and 9, optical communication system 1A includes a multirate transmission unit 26 and a selection unit 27 in place of BM transmission unit 23 and BM transmission unit 25. Optical communication system 1A differs from optical communication system 1 according to Embodiment 1 in this respect.

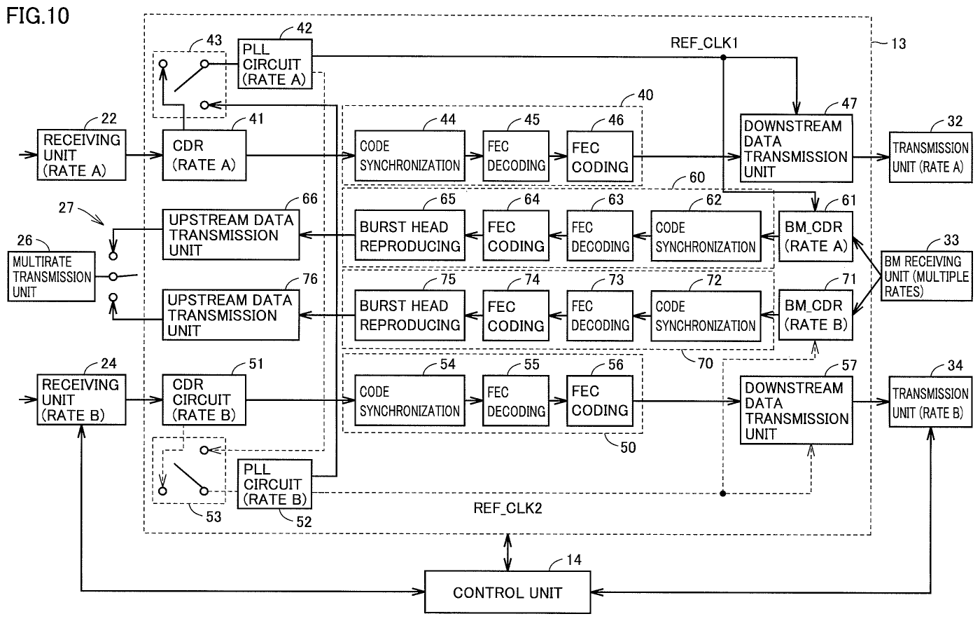

FIG. 10 is a block diagram showing in more detail a configuration related to the transmission of an upstream signal in optical signal repeater 7 shown in FIG. 9.

With reference to FIGS. 2 and 10, multirate transmission unit 26 is configured to transmit both of an upstream signal (rate A) and an upstream signal (rate B). Selection unit 27 selects an input to multirate transmission unit 26 from the upstream signal (rate A) and the upstream signal (rate B). The output of upstream data transmission unit 66 is the upstream signal (rate A), and the output of upstream data transmission unit 76 is the upstream signal (rate B).

Selection unit 27 may be controlled by control unit 14. For example, control unit 14 detects a process for transmission of an upstream signal by upstream data transmission unit 66 or upstream data transmission unit 76. Control unit 14 can control selection unit 27 based on a result of the detection. For example, control unit 14 may detect an operation for output of an optical signal by upstream data transmission unit 66 or upstream data transmission unit 76. In this case, control unit 14 can control selection unit 27 to select an output from the upstream data transmission unit that performs the operation.

Embodiment 2 can stabilize, also before start of a service at a rate of a plurality of rates, the output of the PLL circuit for that rate as in Embodiment 1.

Before start of the service at a rate, data processing units (e.g., data processing units 40 and 50) that are in charge of data transmission at that rate may be stopped. The power consumption of optical signal repeater 7 can thus be reduced as in Embodiment 1. Further, the circuit can start up rapidly at the start of the service, reducing an effect on data transmission.

In the embodiment above, whether the service has been started is determined based on the presence or absence of the optical power of a downstream signal. However, whether the service has been started may be determined based on, for example, variations in the rate of a received downstream signal. Alternatively, whether the service has been started may be determined based on the presence or absence of a downstream control frame.

In each of the above embodiments, the optical signal repeater has two CDR circuits each corresponding to one of two rates. However, the present invention is not limited thereto. The optical signal repeater may include more than two CDR circuits. When three or more CDR circuits are included in the optical signal repeater, the first CDR circuit and the second CDR circuit can be selected appropriately from among a plurality of CDR circuits.

It is to be understood that the embodiments disclosed herein are presented for the purpose of illustration and non-restrictive in every respect. It is therefore intended that the scope of the present invention is defined by claims, not only by the embodiments described above, and encompasses all modifications and variations equivalent in meaning and scope to the claims.

### REFERENCE SIGNS LIST

1, 1A optical communication system, 2 optical line terminal (OLT), 3a, 3b, 3c, 3d optical network unit (ONU), 4a trunk optical fiber, 4b branch optical fiber, 5 optical coupler, 7 optical signal repeater, 11, 12 optical transmission and receiving unit, 13 signal reproducing and processing unit, 14 control unit, 21, 31 WDM filter, 22, 24 receiving unit, 23, 25 BM transmission unit, 26 multirate transmission unit, 32, 34 transmission unit, 33 BM receiving unit, 27, 43, 53 selection unit, 40, 50, 60, 70 data processing unit, 41, 51 CDR circuit, 42, 52 PLL circuit, 44, 54, 62, 72 code synchronization circuit, 45, 55, 63, 73 FEC decoding circuit, 46, 56, 64, 74 FEC coding circuit, 47, 57 downstream data transmission unit, 61, 71 BM_CDR circuit, 65, 75 burst head reproducing circuit, 66, 76 upstream data transmission unit, 81 phase comparator, 82 loop filter, 83 VCO, 84, 85 frequency multiplier and divider, REF_CLKE REF_CLK2 reference clock, S1-S4, S11-S15 step, Sa, Sb optical signal, λa, λb wavelength.

1. An optical signal repeater that repeats a plurality of optical signals, each of which has a corresponding one of a plurality of bit rates and which are subjected to wavelength multiplexing, the optical signal repeater comprising:
a separation unit that separates the plurality of optical signals according to wavelengths;
a first clock data recovery (CDR) circuit configured to extract a first clock included in a first optical signal of the plurality of optical signals and having a first frequency corresponding to a first rate of the plurality of bit rates;
a second CDR circuit configured to extract a second clock included in a second optical signal of the plurality of optical signals and having a second frequency corresponding to a second rate of the plurality of bit rates;
a synchronous circuit that is synchronized with the first clock when the first clock is generated and is synchronized with the second clock when the first clock is not generated and the second clock is generated; and
a control unit that controls the synchronous circuit.

2. The optical signal repeater according to claim 1, wherein the control unit determines presence or absence of a transmission service at the first rate based on input optical power at the first rate and controls the synchronous circuit based on a result of the determination.

3. The optical signal repeater according to claim 1, wherein the control unit determines presence or absence of a transmission service at the first rate based on a frequency of the first clock and controls the synchronous circuit based on a result of the determination.

4. The optical signal repeater according to claim 1, further comprising a data processing unit that performs, on data included in the first optical signal, a process for repeating the data,
wherein with a transmission service at the first rate not being provided, the control unit stops the data processing unit.

5. A method of repeating an optical signal for repeating a plurality of optical signals, each of which has a corresponding one of a plurality of bit rates and which are subjected to wavelength multiplexing, the method comprising:
separating the plurality of optical signals according to wavelengths;
extracting a first clock included in a first optical signal of the plurality of optical signals and having a first frequency corresponding to a first rate of the plurality of bit rates;
extracting a second clock included in a second optical signal of the plurality of optical signals and having a second frequency corresponding to a second rate of the plurality of bit rates;
synchronizing a synchronous circuit with the first clock to generate a reference clock when the first clock is generated;
synchronizing the synchronous circuit with the second clock when the first clock is not generated and the second clock is generated; and
repeating an optical signal having the first rate using the reference clock.

6. An optical communication system comprising:
an optical line terminal that multiplexes a plurality of optical signals in accordance with a wavelength division multiplexing mode and transmits a multiplex optical signal, each of the plurality of optical signals having a corresponding one of a plurality of bit rates and having a corresponding one of a plurality of wavelengths each corresponding to one of the plurality of bit rates;
an optical communication line for transmitting the plurality of optical signals from the optical line terminal;
a plurality of optical network units each connected to the optical communication line to receive an optical signal having a corresponding rate of the plurality of bit rates; and
an optical signal repeater provided partway along the optical communication line, the optical signal repeater including
a separation unit that separates the plurality of optical signals according to wavelengths,
a first clock data recovery (CDR) circuit configured to extract a first clock included in a first optical signal of the plurality of optical signals and having a first frequency corresponding to a first rate of the plurality of bit rates,
a second CDR circuit configured to extract a second clock included in a second optical signal of the plurality of optical signals and having a second frequency corresponding to a second rate of the plurality of bit rates,
a synchronous circuit that is synchronized with the first clock when the first clock is generated and is synchronized with the second clock when the first clock is not generated and the second clock is generated, and
a control unit that controls the synchronous circuit.

7. The optical communication system according to claim 6, wherein the first rate and the second rate each generated in the optical line terminal are synchronized with each other.
